(19) United States
(12) Patent Application Publication
(10) Pub. No.: US 2013/0195592 A1
(43) Pub. Date: Aug. 1, 2013

(54) Push-Pull Device, Fork-Lift Truck and Method for Displacing Goods

(71) Applicant: Hendrik Meijer, Westhoek (NL)

(72) Inventor: Hendrik Meijer, Westhoek (NL)

(73) Assignee: GEBR. MEIJER ST. JABIK B.V., St. Jacobiparochie (NL)

(21) Appl. No.: 13/639,762

(22) PCT Filed: Apr. 4, 2011
(86) PCT No.: PCT/NL11/50225

§ 371 Date: Oct. 24, 2012

(30) Foreign Application Priority Data
Apr. 8, 2010 (NL) 2004526

(51) Int. Cl. B66F 9/12; B66F 9/19

(52) U.S. Cl. CPC B66F 9/12; B66F 9/195
USPC 414/661; 414/814

(57) ABSTRACT

A push-pull device (4), a fork-lift truck (2) provided therewith and a method therefor. The push-pull device comprises:—a carrier element (6) on which the goods can be placed;—a gripping mechanism (12) for gripping goods to be transported; and—a push-off mechanism for pushing off the carrier element goods placed thereon, wherein the push-off mechanism comprises at least two drive mechanisms A lateral adjusting mechanism is preferably provided for adjusting the at least two drive mechanisms in lateral direction.

The present invention relates to a pushing-pulling device for mounting on a lifting device. Such a lifting device is for instance a fork-lift truck or pallet truck. Pushing-pulling devices are also referred to as “push-pull” devices.

Push-pull devices known in practice are generally used to pull goods onto a carrier element. The carrier element is for instance mounted here on a fork-lift truck. Once the goods have been pulled onto such a carrier element, these goods can be displaced using the fork-lift truck. After the goods have been taken to the desired location, they are pushed off the carrier element using a push plate. The goods to be displaced are situated here for instance on a so-called slip sheet. Such a slip sheet is in practice gripped with a type of clamping or gripping mechanism and then pulled onto the carrier element or the carrier plate. When being set down these goods are pushed off the carrier element by the pushing mechanism with or without slip sheet and set down at the desired position. A drawback of the known push-pull devices is the limited flexibility for variation in dimensions of the goods to be displaced.

The present invention has for its object to obviate or at least reduce the above stated problems with the known push-pull devices.

The present invention provides for this purpose a push-pull device for mounting on a lifting device, the push-pull device comprising:
a carrier element on which goods can be placed;
a gripping mechanism for gripping goods to be transported; and
a push-off mechanism for pushing off the carrier element goods placed thereon, wherein the push-off mechanism comprises at least two drive mechanisms.

The goods to be displaced are usually provided on a slip sheet. It will be apparent to the skilled person that goods can also be provided in other manner, for instance on a sheet of plywood, plastic or cardboard. The slip sheet is gripped using a gripping mechanism, after which it is pulled onto a carrier element. Instead of being gripped on a slip sheet, the goods for transporting can also be gripped in other manner using the gripping mechanism. The carrier element is for instance a carrier plate or blade fork. It is possible here for this carrier plate to consist of for instance two parts, wherein each part is mounted on a fork carrier of a fork-lift truck. The push-pull mechanism pulls the goods for transporting, which are gripped by the gripping mechanism, onto the carrying element and the goods are then transported. After transport the goods are pushed off the carrier element using a push plate or push-off mechanism of the push-pull mechanism. The gripping mechanism is preferably connected to the push plate or push-off mechanism. The push-pull mechanism according to the present invention is provided here with at least two separate drive mechanisms.

An additional advantage of the use of at least two drive mechanisms is that the forces transmitted to the goods for transporting are distributed better as the goods are pushed off the carrier plate. This for instance avoids the goods for transporting on the carrier element being pushed to one side. Owing to the better distribution of forces it is also possible in the case of a fragile load to avoid damage thereto. A further additional advantage of the use of two drive mechanisms is that the view is improved for an operator of a lifting device. It is preferably possible for the operator to see between the two mechanisms and get a view of the goods to be picked up.

The at least two drive mechanisms preferably comprise two scissor mechanisms. A construction suitable for pushing the goods for transporting off the carrier element as well as for pulling them thereon is obtained in effective manner by providing two scissor mechanisms. Such a scissor mechanism is preferably provided with a cylinder, wherein the scissor mechanism is also extended by sliding out the cylinder. After the load has been gripped or the load removed from the carrier element, the scissor mechanism can be retracted to the starting position by sliding in the cylinder.

In an advantageous preferred embodiment according to the invention a lateral adjusting mechanism is provided for adjusting the at least two drive mechanisms in lateral direction.

A lateral adjusting mechanism achieves that the at least two drive mechanisms can be adjusted in lateral direction. It is hereby possible to bring the at least two drive mechanisms closer together, or conversely move them apart. This adjustment can be adapted to the goods for transporting. Hereby achieved is that a greater flexibility is obtained for the push-pull device with the present invention for transporting goods having varying dimensions.

In an advantageous embodiment according to the present invention the lateral adjusting mechanism comprises a hydraulic drive.

By providing a hydraulic drive the adjusting mechanism can be set correctly in simple manner such that it is adapted to the dimensions of the goods for transporting. A work-friendly embodiment is hereby obtained. In combination herewith or as an alternative hereto, the lateral adjusting mechanism can comprise a manual drive. A manual drive provides either a less complex embodiment for this driving of the lateral adjusting mechanism or an addition, or optionally a fine adjustment for the lateral adjusting mechanism relative to the hydraulic drive.

In an advantageous preferred embodiment according to the present invention the push-off mechanism is carried during use by the carrier element.

Having the push-off mechanism, preferably connected to a scissor mechanism, carried by the carrier element achieves that the push-off mechanism remains close to the carrier element, such as the fork, on the underside. Among other things, a good engagement of the clamping mechanism on the slip sheet is hereby realized. This is advantageous for instance if relatively heavy goods rest on the carrier element and this bends to a certain extent. Supporting of the push-off mechanism is realized by providing a hinged connection between the drive or scissor mechanism and the lifting device. The push-off mechanism, and preferably the clamping mechanism, can hereby follow the shape and/or bending of the carrier element. The distance from the clamping mechanism to the carrier remains substantially the same, this being favourable for pulling of the slip sheet. This avoids a slip sheet breaking if a load rests on the carrier element and this element bends, whereby the distance from the gripping mechanism, or clamping mechanism, to the carrier element becomes too great. The push-off mechanism with clamping mechanism hereby has the option of both horizontal displacement and vertical displacement and thereby preferably follows the line of the carrier element, this during use of both roller forks and blade forks. Pulling of the slip sheet can hereby be carried out in advantageous manner.

In an advantageous preferred embodiment according to the present invention the device comprises a support hinge for pivotally connecting the carrier element to the lifting device.

Providing the carrier element, for instance a blade fork, in pivoting manner with the lifting device, and particularly for instance the mast thereof, achieves that the carrier element remains horizontal irrespective of the situation of for instance the mast. This means that the mast can incline to some extent while the carrier element simultaneously remains horizontal. This is advantageous for instance when goods are being picked up from the floor, wherein this can be carried out more quickly and the chance of damage is additionally reduced.

In an advantageous preferred embodiment according to the present invention the push-pull mechanism comprises a separate push-off plate for each of the at least two drive mechanisms.

Providing a separate push-off plate makes it possible to control the drive mechanisms separately if desired. This is advantageous for instance if goods of relatively small dimensions are being transported, such that a plurality of goods can be placed on the carrier element. This is also advantageous due to the better distribution of forces. This is particularly advantageous in the case of irregularly shaped goods.

The separate push-off plates can preferably be mutually coupled. The mutual coupling makes it possible to move the coupled push-off plate together with the at least two drive mechanisms. A uniform unit for the push-pull mechanism is hereby realized.

In an advantageous preferred embodiment according to the present invention the carrier element and/or push-off plate can be coupled to widening pieces.

By providing the carrier element with coupling means to which widening pieces can be attached it is possible to widen and thereby further adapt this carrier element, for instance in the form of a carrier plate, to the dimensions of the goods for transporting. This further increases the range of goods which can be transported using the push-pull device according to the present invention. It is also possible to provide widening pieces for the push-off plate or push-off plates. Said range is hereby also further increased.

In an advantageous preferred embodiment according to the present invention the at least two drive mechanisms are provided with a synchronizing system.

Providing a synchronizing system achieves that the cylinders of the drive mechanism, for instance in the form of a scissor mechanism, are extended and retracted in equal measure. This synchronizing system is preferably embodied as a hydraulic sub-system, wherein the two hydraulic cylinders of the at least two scissor mechanisms are connected using a valve. A synchronizing system is obtained in a manner known to the skilled person by adjusting the volumes of the cylinders and realizing a connection between these two cylinders.

Volumes of the two cylinders are here adapted to each other. As already stated above, it is a possibility here to control the at least two drive mechanisms in coupled manner, preferably using a synchronizing system, or separately. This is for instance adapted to the dimensions of the goods for transporting. This achieves a great flexibility in respect of the goods for transporting.

A further additional advantage of providing a synchronizing system is that the simultaneous clamping of for instance the slip sheet can also be ensured. The gripping of such a slip sheet is further improved as a result, whereby placing of the goods on the carrier element can be better managed and controlled.

In a further advantageous preferred embodiment according to the present invention the carrier element comprises a roller fork.

Roller forks are per se known and are described in NL 1018793. The carrier frame in such a roller fork is provided with at least one double roller device which is arranged in longitudinal direction and in which a number of first roller elements situated at regular mutual distances are arranged. The roller fork further comprises a number of second roller elements situated above the first roller elements. Both roller elements have a rolling surface, wherein the rolling surface of the first roller elements lies against the rolling surface of the second roller elements. The roller elements are further provided in the support frame for movement in vertical direction.

The second roller element will have at least two positions, a first position, when goods are being carried during transport, wherein the second roller elements have no contact with the goods but are guided to a lower position in the frame. The goods engage on the support frame and do not slide during transport. In the second position the first roller elements engage on the support surface on which the goods are placed and the second roller elements can engage on the goods.

When in fact the loading platform rolls over the support surface with the first roller elements during loading and unloading in the second position, the rolling surfaces of the two roller elements make contact such that the second roller elements also roll. In the case of a loading platform moving to the right, the first roller elements roll clockwise. The second roller elements on the other hand roll counter-clockwise.

The second roller elements protrude partially from the internal mechanism of the loading platform through the upper surface of the loading platform. The protruding rolling surfaces of the second roller elements carry the load arranged on the upper side of the loading platform. The rolling movement of the second roller elements ensures that the load is stationary relative to the support surface, while the loading platform is moved under the load. The load is thus shovelled onto the loading platform.

During setting down of the goods the loading platform will move out from under the load as the lifting device moves in reverse. The roller elements co-act such that the load is shifted off the loading platform such that the load does not move relative to the ground surface.

An efficient displacement of goods becomes possible by combining the carrier element with the roller fork. It is thus for instance possible using the roller fork to pick up and/or set down goods placed on the ground. The push-pull device with for instance the scissor mechanisms is then employed particularly when picking up or setting down goods at height.

If desired, it is possible to interchange or apply the roller forks and blade forks subject to the goods for transporting. The flexibility of the push-pull device according to the present invention is hereby further increased.

In a further advantageous preferred embodiment according to the present invention the push-pull device comprises a fork adjuster operatively connected to the lateral adjusting mechanism.

By providing at least two drive mechanisms and a lateral adjusting mechanism it is possible to provide these at least two drive mechanisms at any desired mutual distance. As described, this achieves the flexibility for handling a wide variety of dimensions of goods for transporting. By connecting the lateral adjusting mechanism to a fork adjuster it is possible to further simplify the setting or adjustment of the separate drive mechanisms when applied on a fork-lift truck provided with a push-pull device according to the present invention. This further increases the flexibility of the push-pull device according to the invention.

The present invention further relates to a fork-lift truck provided with a push-pull device as described above.

Such a fork-lift truck provides the same effects and advantages as described in respect of the device.

The present invention further also relates to a method for displacing goods, comprising of providing a push-pull device as described above.

Such a method provides the same effects and advantages as described in respect of the device. The flexibility for handling a wide variety of goods for transporting is particularly increased with the method according to the invention when the so-called slip sheets are used. It hereby becomes possible to apply such slip sheets more frequently. Advantages hereof are lower costs in respect of purchase and transport, and a reduction in operations to be carried out for the purpose of this transport.

Further advantages, features and details of the invention are elucidated on the basis of preferred embodiments thereof, wherein reference is made to the accompanying drawings, in which:

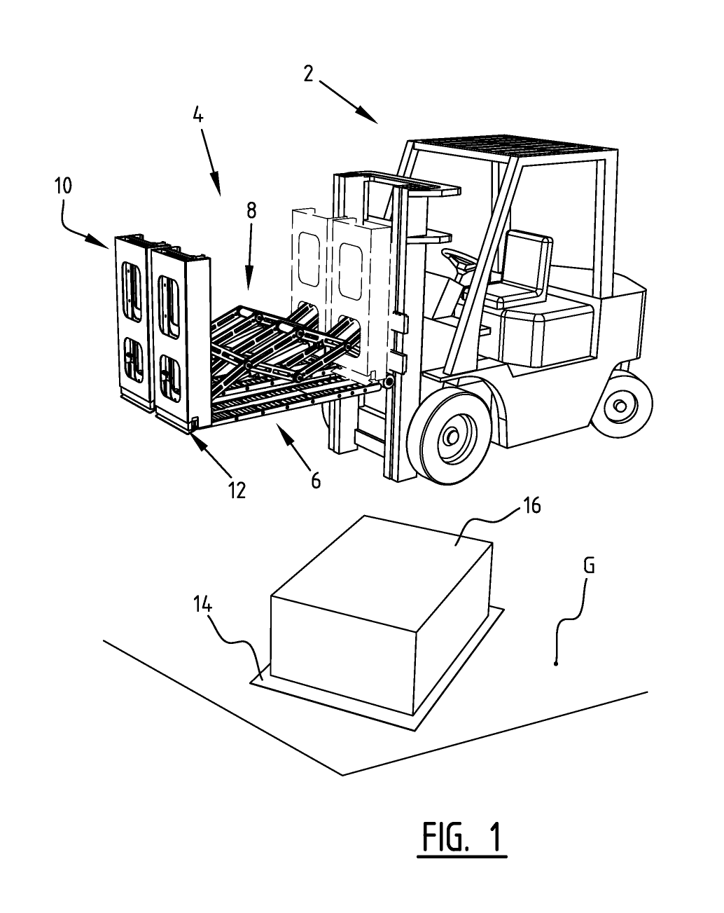

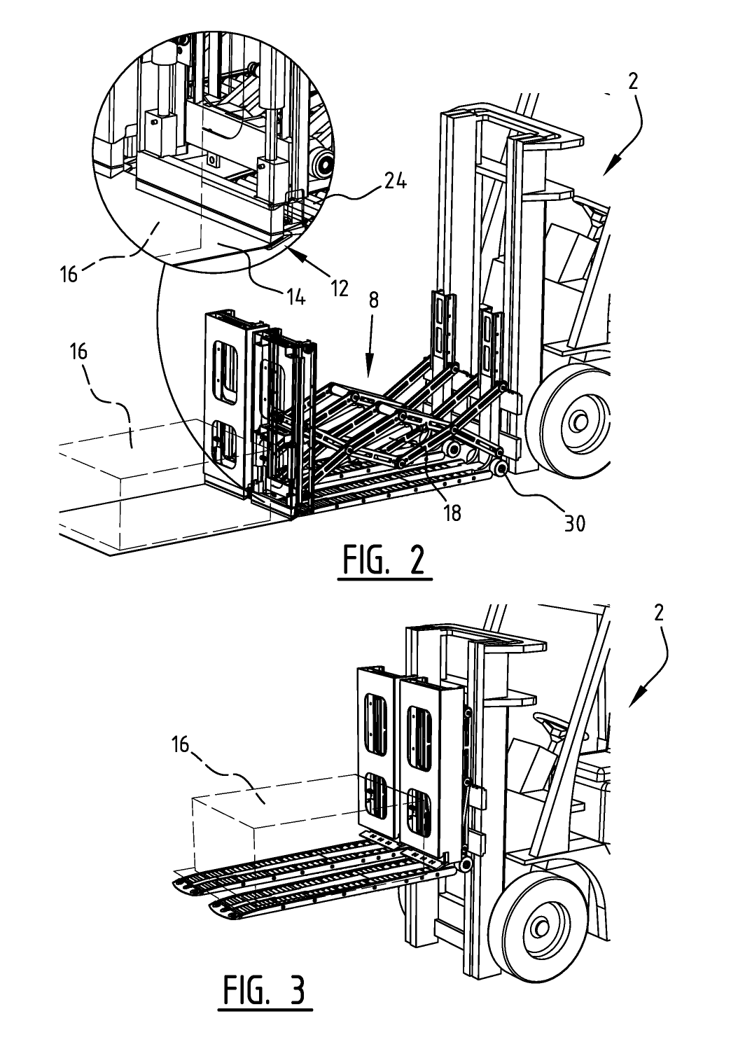

FIGS. 1 and 2 show a fork-lift truck provided with a push-pull device according to the invention;

FIG. 3 shows a view of the fork-lift truck of FIG. 1 during transport of goods;

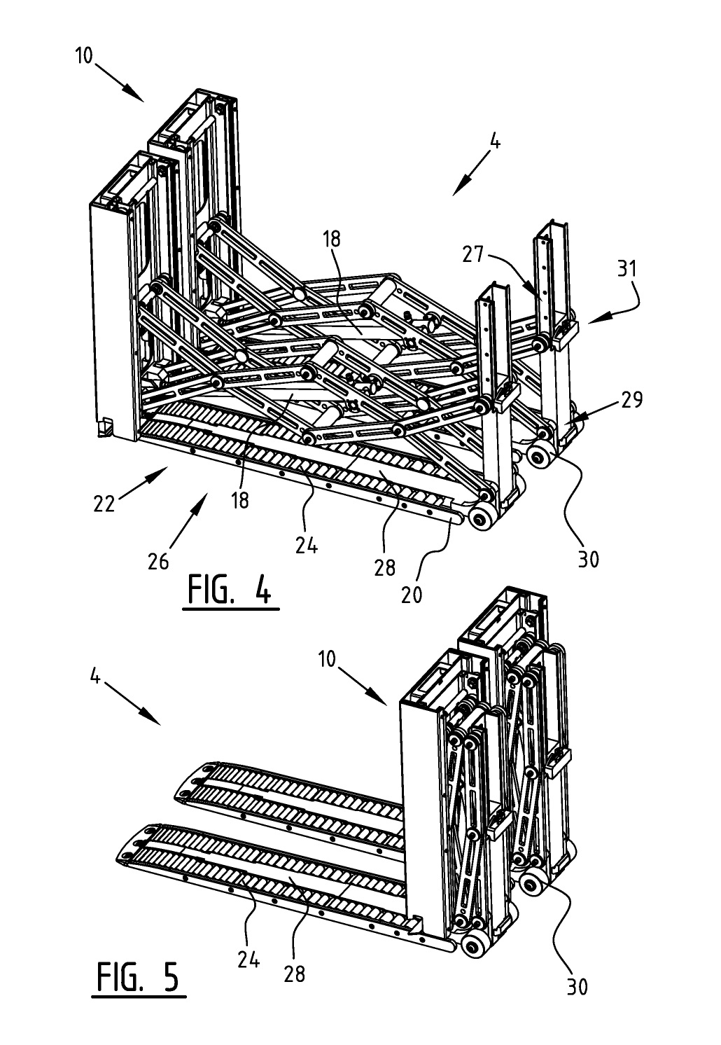

FIGS. 4 and 5 show a top view of the push-pull device; and

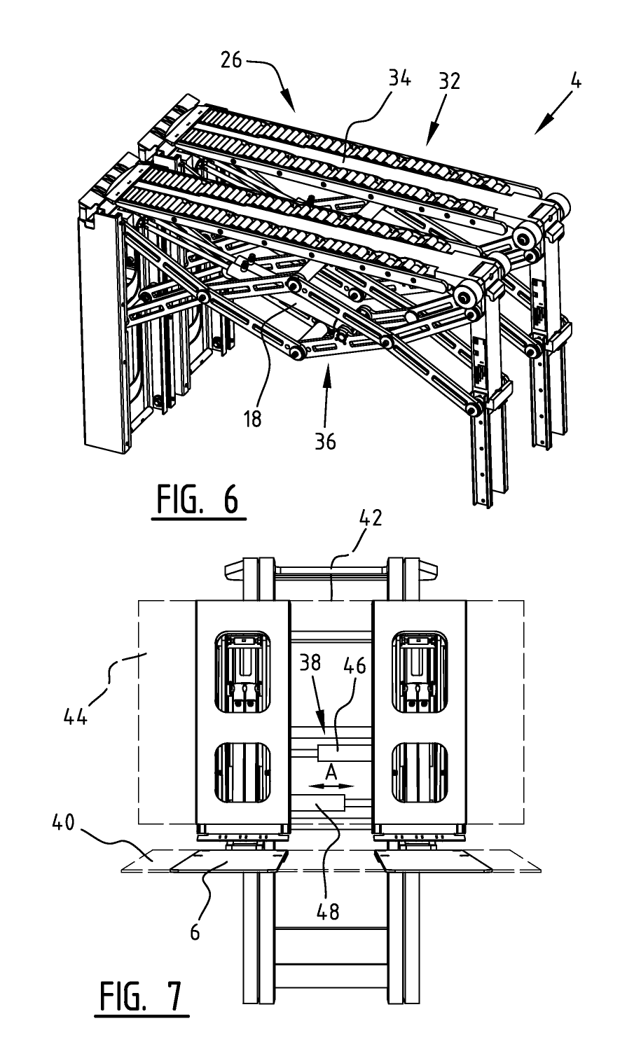

FIG. 6 shows a bottom view of the push-pull device of FIGS. 4 and 5;

FIG. 7 shows a front view of a fork-lift truck according to the invention provided with, among other parts, a fork adjuster; and

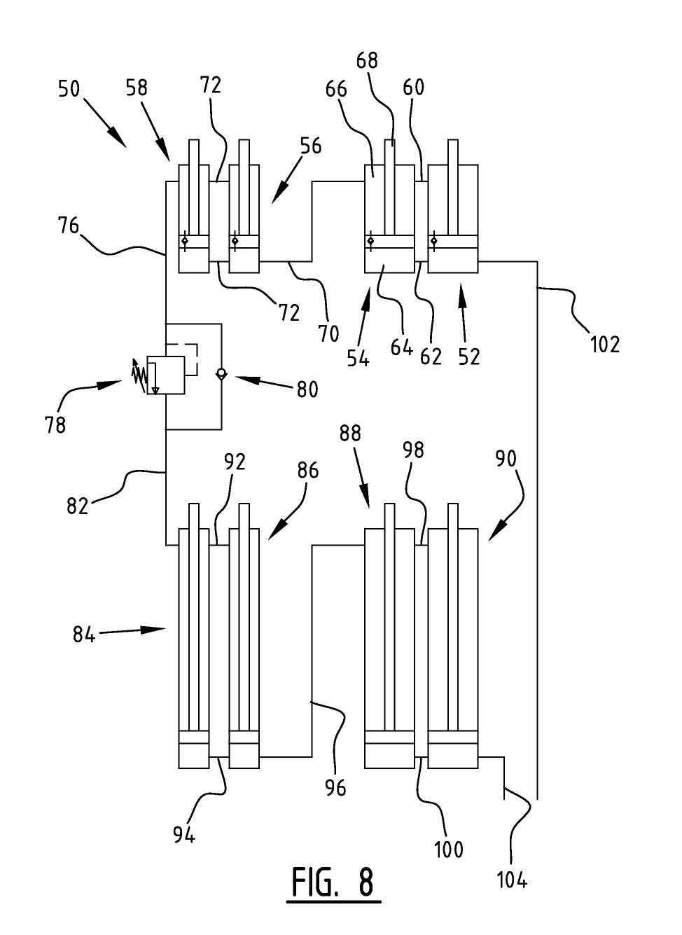

FIG. 8 shows a hydraulic diagram of an embodiment of the push-pull device according to the invention.

A fork-lift truck 2 (FIG. 1) is provided with push-pull device or push-pull system 4. System 4 comprises a carrier plate 6 and a scissor mechanism 8. Scissor mechanism 8 makes it possible to extend push plate 10 (full lines) and retract it (broken lines) in a horizontal movement. Provided under push plate 10 is gripping mechanism 12 with which for instance a slip sheet 14 can be gripped. On a ground G the goods for transporting 16 can be placed on such a slip sheet 14. In the shown embodiment system 4 (FIG. 2) comprises two scissor mechanisms 8 with which a separate push plate 10 can be moved in horizontal direction per scissor mechanism 8. The movement of a scissor mechanism 8 is realized using a cylinder 18. Extending of cylinder 18 provides for the forward movement, as seen from the operator of a fork-lift truck 2 on which system 4 can be mounted. Retracting of cylinder 18 provides for the retraction of scissor mechanism 8 such that push-off plate 10 moves in the direction of the operator of fork-lift truck 2. With gripping mechanism 12 goods 16 on slip sheet 14 are transported with fork-lift truck 2 while being carried on carrier plate 6 (FIG. 3).

In the shown embodiment carrier plate 6 (FIGS. 4 and 5) is provided with a side edge or profile 20 inside which is situated a roller fork or roller device 22 provided with an upper row of roller elements 24. In the shown embodiment two rows of rollers 24 are positioned adjacently of each other per fork 26 at a mutual distance defined by carrier part 28. In a manner known to the skilled person rollers 24 are provided in carrier plate 6 for movement in vertical direction. Using a guide 27 scissor mechanism 8 is mounted on the upright connected to the lifting device. On the underside scissor mechanism 8 is provided on a flange of fork 26 using hinge 29. In the shown embodiment guide 27 and hinge 29 are embodied such that the push-off plates can make a vertical movement so that they can follow the shape of profile 20 and/or the bending thereof. System 4 is further provided with shaft 30 on which wheels are mounted, thereby simplifying the displacement. Shaft 30 makes a pivoting movement possible between carrier part 28 and the lifting device. Owing to the described connections it is possible in the shown embodiment for the upright to form an angle to fork 26 while the push-off plate substantially remains resting on fork 26. System 4 is also provided with a coupling 31 with which a connection to for instance fork-lift truck 2 is realized.

When carrier plate 6 rests on ground G, lower rollers 32 (FIG. 6) are pressed upward such that they press the upper row of rollers 24 upward above the carrying surface of carrier part 28, so that the goods for transporting 16 are carried by rollers 24, optionally on slip sheet 14. The movement of carrier plate 6 over ground G ensures that forks 26 move relative to goods 16. This further simplifies placing of goods 16 on carrier plate 6 and pushing them off it again. This is particularly relevant when goods have to be lifted from ground G or have to be set down on ground G. Provided per fork 26 on the underside of carrier plate 6 in the shown embodiment are two rows of lower rollers 32 which are placed at a mutual distance defined by sliding part 34. In the shown embodiment sliding part 34 is embodied in combination with carrier part 28. Cylinders 18 of scissor mechanism 8 are further provided in the shown embodiment with a synchronizing system 36 comprising a mutual connection and valve. The embodiment of such a hydraulic synchronizing system 36 is known to the skilled person.

System 4 (FIG. 7) can be combined with a fork adjuster 38. Such fork adjusters 38 are per se known to the skilled person. In order to make system 4 suitable for relatively great loads, it is possible to widen carrier plate 6 using widening pieces 40 which can be coupled to carrier plate 6. Push-off plates 10 can be mutually connected using couplings 42. Push plate 10 can also be widened using widening piece 44, for instance for the purpose of a large load for transporting. In the shown embodiment two cylinders 46,48 are provided for performing the lateral movement in direction A.

Hydraulic diagram 50 (FIG. 8) is provided with two cylinders 52,54 on a first side of clamping mechanism 12 and two cylinders 56,58 on a second side. Mutual connections 60,62 are provided between cylinders 52,54. In the shown embodiment the bore of first cylinders 52,54 is embodied as 35 mm, and as 30 mm for second cylinders 56,58. The ratio of a first volume 64 and a second volume 66 of the individual cylinders, influenced by the dimension of rod 68 and being 18 mm in the shown embodiment, is chosen such that the size of second volume 66 of first cylinder 54 corresponds to the size of first volume 64 of second cylinder 56 with the smaller bore. The same movement is hereby realized with cylinders 52,54,56,58. Line 70 connects cylinders 54 and 56. Provided at the outlet of cylinder 58 is line 76 which leads to sequence valve 78 at which a valve 80 is provided. Only after cylinders 52,54,56,58 of the clamping mechanism have been extended and the clamping opened or released is valve 78 opened, for instance at a pressure of about 30 bar. Valve 78 is connected to cylinder 84 of extending or scissor mechanism 8 via line 82. First cylinders 84,86 and second cylinders 88,90 of scissor mechanism 8 are mutually connected in the same manner as cylinders 52,54,56,58 of the clamping mechanism with lines or connections 92,94,96,98,100. The oil is supplied via line 102 and discharged via line 104 from and to a reservoir (not shown).

In an alternative embodiment of the hydraulic diagram (not shown) it is possible to embody the clamping mechanism independently of the extending mechanism of the scissor mechanism. This is particularly advantageous in the case use is made of roller folks 22 in combination with push-pull system 4. Load 16 can be removed here from roller fork 22 without a displacement of push plates 10 being required.

For the purpose of displacing goods 16 provided on a slip sheet 14 on ground G, a fork-lift truck 2 provided with system 4 is moved toward goods 16. Gripping mechanism 12 engages on and fixedly clamps the edge of slip sheet 14. Scissor mechanism 8 is then retracted using cylinder 18 such that slip sheet 14 with goods 16 thereon is pulled onto carrier plate 6. If desired, use can be made here of roller forks 22. After goods 16 have been placed thereon, carrier plate 6 can be moved upward using fork-lift truck 2 to enable further transport of goods 16. Once the desired set-down position has been reached, carrier plate 6 is moved to the desired vertical position, for instance ground G. Goods 16 are then pushed off slip sheet 14 using push plate 10 by extending scissor mechanism 8 and cylinders 18. Goods 16 are hereby set down at the desired location. Cylinder 18 is then retracted so that push plates 10 once again move back in horizontal direction to the starting position.

For the purpose of unloading goods 16, for instance from a container, use is made in an advantageous embodiment of a roller fork 22. Several steps can hereby be skipped in picking up the load 16 lying on the floor and, in both cases (upper and lower pallet) in moving load onto so-called in-house pallets. A number of steps are performed in unloading an upper load from a two-high stack in a container. The clamping mechanism moves forward and subsequently clamps the slip sheet. The clamping mechanism then moves rearward and the slip sheet with load 16 is pulled rearward over roller fork 22. When unloaded cargo is placed on a pallet, the clamping mechanism releases the slip sheet in the rearmost position. The load is placed on a pallet by means of roller forks 22. During unloading from the container of a lower load on the floor roller forks 22 roll under the slip sheet. Roller forks 22 are used once again when this load is then placed on a pallet.

If blade forks are used instead of roller forks 22, a number of steps are likewise performed in the above stated operations for unloading an upper load from a two-high stack in a container. The clamping mechanism first moves forward. In extended position the clamping mechanism clamps the slip sheet. The clamping mechanism moves rearward and the slip sheet with load is pulled rearward over the blade forks. During placing of the unloaded cargo on a pallet the clamping mechanism and push plate push load 16 forward over the blade forks. In extended position the clamping mechanism releases the slip sheet and the load is situated on a pallet. The clamping mechanism moves rearward for a subsequent cycle. During unloading from a container of a lower load placed on the floor the clamping mechanism moves forward, and in extended position the clamping mechanism clamps the slip sheet. The clamping mechanism moves rearward and the slip sheet with load is pulled rearward over the blade forks. For subsequent placing of the unloaded cargo on a pallet the clamping mechanism and push plate push load 16 forward over the blade forks. In extended position the clamping mechanism releases the slip sheet, and the load is situated on the pallet. The clamping mechanism then moves rearward for a subsequent cycle.

In order to unload narrower loads the two scissor mechanisms are preferably moved toward each other so that the load lies centred on the carrier, roller fork or blade fork. A conventional push-pull system has a fixed width, and the load will not be picked up in centred manner. Assume that a pallet is 1200 mm wide and 800 mm wide. A conventional push-pull system is 1000 mm wide and, if an 800 mm wide pallet is picked up, the load is positioned 200 mm away from the side.

The present invention is by no means limited to the above described preferred embodiments thereof. The rights sought are defined by the following claims, within the scope of which many modifications are possible. It is thus possible for instance to apply system 4 on a pallet truck instead of on a fork-lift truck 2.

1. Push-pull device for mounting on a lifting device, comprising:
a carrier element on which goods can be placed;
a gripping mechanism for gripping goods to be transported; and
a push-pull mechanism for pushing off the carrier element goods placed thereon,
wherein the push-pull mechanism comprises at least two drive mechanisms.

2. Push-pull device as claimed in claim 1, wherein the at least two drive mechanisms comprise two scissor mechanisms.

3. Push-pull device as claimed in claim 1, wherein the push-off mechanism is carried during use by the carrier element.

4. Push-pull device as claimed in claim 1, comprising a lateral adjusting mechanism for adjusting the at least two drive mechanisms in lateral direction.

5. Push-pull device as claimed in claim 4, wherein the lateral adjusting mechanism comprises a hydraulic drive.

6. Push-pull device as claimed in claim 4, wherein the lateral adjusting mechanism comprises a manual drive.

7. Push-pull device as claimed in claim 1, comprising a support hinge for pivotally connecting the carrier element to the lifting device.

8. Push-pull device as claimed in claim 1, wherein the push-pull mechanism comprises a separate push-off plate for each of the at least two drive mechanisms.

9. Push-pull device as claimed in claim 8, wherein the separate push-off plates can be mutually coupled.

10. Push-pull device as claimed in claim 1, wherein the carrier element and/or push-off plate can be coupled to widening pieces.

11. Push-pull device as claimed in claim 1, wherein the at least two drive mechanisms are provided with a synchronizing system.

12. Push-pull device as claimed in claim 1, wherein the carrier element comprises a roller fork.

13. Push-pull device as claimed in claim 1, further comprising a fork adjuster operatively connected to the lateral adjusting mechanism.

14. Fork-lift truck provided with a push-pull device as claimed in claim 1.

15. Method for displacing goods, comprising of providing a push-pull device as claimed in claim 1.
